(19) United States
(12) Patent Application Publication
(10) Pub. No.: US 2026/0147598 A1
(43) Pub. Date: May 28, 2026

(54) STORAGE PROVISIONING AMONG MULTIPLE STORAGE CONTROLLERS FOR DYNAMIC VIRTUAL MACHINE REQUIREMENTS

(71) Applicant: International Business Machines Corporation, Armonk, NY (US)

(72) Inventors: Chhavi AGARWAL, Bengaluru (IN); Shyama VENUGOPAL, Hyderabad (IN); Joseph W. CROPPER, Round Rock, TX (US); Imranuddin Wakaruddin KAZI, Hyderabad (IN)

(21) Appl. No.: 18/956,114

(22) Filed: Nov. 22, 2024

(51) Int. Cl. G06F 9/455

(52) U.S. Cl. CPC G06F 9/45558; G06F 2009/45579; G06F 2009/45583

(57) ABSTRACT

A method includes provisioning a first storage configuration to meet a storage requirement of a first virtual machine according to capabilities provided by individual storage controllers. The storage requirement comprises a plurality of volumes. In the first storage configuration at least a first volume is assigned to a first storage controller, and at least a second volume is assigned to a second storage controller. The method further comprises receiving an update to the storage requirement, the update specifying at least one capability not provided in the first storage configuration. The method further comprises provisioning a second storage configuration to meet the update to the storage requirement. Provisioning the second storage configuration comprises identifying a single storage controller that provides the at least one capability and sufficient capacity for the plurality of volumes. The method further comprises assigning the plurality of volumes to the single storage controller.

### BACKGROUND

The present disclosure relates to storage systems, and more specifically, to the dynamic provisioning of storage responsive to changes in storage requirements for virtual machines.

Providing enterprise-class storage solutions within a multi-tenant public cloud environment requires the ability to accommodate a wide range of client use cases. The specific demands that will be placed on the cloud-based infrastructure to support these use cases may not be well-settled, as certain scenarios may not be known at the time the storage resources are initially provisioned to the clients. One particular example of changing demands is clients enabling cross-regional storage-level replication that provides disaster recovery for their virtual machines (VMs).

### SUMMARY

According to one embodiment, a method comprises provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The method further comprises receiving an update to the storage requirement of the first virtual machine, the update specifying at least one capability that is not provided in the first storage configuration. The method further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The method further comprises assigning the plurality of volumes to the single storage controller.

According to one embodiment, a computer program product comprises a computer-readable storage medium having computer-readable program code embodied therewith. The computer-readable program code is executable by one or more computer processors to perform an operation comprising provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The operation further comprises receiving an update to the storage requirement of the first virtual machine, the update specifying at least one capability that is not provided in the first storage configuration. The operation further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The operation further comprises assigning the plurality of volumes to the single storage controller.

According to one embodiment, a system comprises a memory and one or more processors configured to perform an operation comprising provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The operation further comprises receiving an update to the storage requirement of the first virtual machine, the update specifying at least one capability that is not provided in the first storage configuration. The operation further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The operation further comprises assigning the plurality of volumes to the single storage controller.

### BRIEF DESCRIPTION OF THE DRAWINGS

FIG. 1 is a block diagram of an exemplary computing environment, according to one or more embodiments.

FIG. 2 is a block diagram of an exemplary system for provisioning storage resources, according to one or more embodiments.

FIG. 3 is an exemplary method of provisioning storage resources responsive to changes in storage requirements for virtual machines, according to one or more embodiments.

FIGS. 4A and 4B are block diagrams illustrating an exemplary sequence of provisioning storage resources responsive to changes in storage requirements for a virtual machine, according to one or more embodiments.

FIGS. 5A and 5B are block diagrams illustrating an exemplary sequence of provisioning storage resources responsive to changes in storage requirements for virtual machines, according to one or more embodiments.

### DETAILED DESCRIPTION

According to one embodiment, a method comprises provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The method further comprises receiving an update to the storage requirement of the first virtual machine, the update specifying at least one capability that is not provided in the first storage configuration. The method further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The method further comprises assigning the plurality of volumes to the single storage controller.

The method may provide a number of benefits. By leveraging the capabilities of the individual storage controllers, the storage resources will be more efficiently distributed based on the performance or functional needs of the virtual machine, reducing computing resource requirements and reducing power consumption. By adapting to updates in the storage requirements, the method allows the efficient handling evolving workloads or applications that demand new or upgraded storage capabilities. By identifying a single storage controller that can accommodate all volumes with the required capabilities, the method is effective to consolidate storage, reduce overhead, improve data locality, and streamline the management of the workloads. The method is used within a multi-controller environment, allowing the system to scale to accommodate complex storage architectures and diverse virtual machine requirements. Dynamically reassigning volumes to meet updated requirements may provide enhanced fault tolerance, as resources may be redistributed responsive to potential performance or capability gaps.

In one embodiment, the at least one capability comprises one or more of the following: an input/output operations per second (IOPS) setting; replication; cloning; snapshotting; compression; volume encryption; and safeguarded copying. Beneficially, by tailoring storage provisioning based on specific technical capabilities, the method ensures compatibility with a wide range of workload requirements. Compatibility with certain capabilities such as encryption, safeguarded copying, and replication provides improved data integrity and security. The IOPS setting allows storage controllers to be tuned to meet performance needs, improving the efficiency of resource utilization.

In one embodiment, identifying the single storage controller is based on one or more of the following: a count of volumes, of the plurality of volumes, to be reassigned to the single storage controller; a size of the plurality of volumes; an available capacity of a storage resource communicatively connected with the single storage controller; and one or more properties required by the storage resource. Beneficially, identifying the single storage controller allows more precise selection, which can result in better load balancing and efficient use of capacity and capabilities. Identifying the single storage controller can streamline reassignment by minimizing disruptions and downtime, and can improve the adaptability of the method to larger, more complex systems by considering resource properties and controller capacity.

In one embodiment, receiving the update to the storage requirement comprises receiving a storage request. Beneficially, the method supports dynamic allocation and enables real-time provisioning responsive to user or system demands.

In one embodiment, the method further comprises provisioning, among the plurality of storage controllers, at least a third storage configuration to meet storage requirements of at least a second virtual machine. Provisioning the second storage configuration to meet the update to the storage requirement comprises determining whether to reconfigure the third storage configuration. Beneficially, the method provides resource conflict resolution through efficient resource distribution across multiple virtual machines, namely by evaluating the impact of changes on other configurations. The intelligent adjustments across the virtual machines can improve resource utilization without compromising performance, and offers flexibility to adapt to dynamic multi-tenant environments where resource demands are evolving.

In one embodiment, the method further comprises assigning a priority to each of the first virtual machine and the second virtual machine based on a respective count of volumes to be reassigned. A lesser count corresponds to a greater priority. Provisioning the second storage configuration is in accordance with the assigned priority.

Beneficially, implementing a systematic, priority-based approach provides conflict mitigation by reducing contention for resources. Use of the priorities ensures that reconfigurations can be aligned with the urgency of needs, improving system reliability and user satisfaction. Further, prioritization supports a transparent and predictable process to resolve resource-constrained scenarios.

In one embodiment, receiving the update to the storage requirement is responsive to a periodic check of the volumes assigned to the plurality of storage controllers. The periodic check supports proactive maintenance by anticipating and resolving potential mismatches or inefficiencies before they impact performance. The method can improve reliability by ensuring the storage configurations are aligned with up-to-date requirements.

According to one embodiment, a computer program product comprises a computer-readable storage medium having computer-readable program code embodied therewith. The computer-readable program code is executable by one or more computer processors to perform an operation comprising provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The operation further comprises receiving an update to the storage requirement of the first virtual machine, the update specifying at least one capability that is not provided in the first storage configuration. The operation further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The operation further comprises assigning the plurality of volumes to the single storage controller.

The computer program product may provide a number of benefits. By leveraging the capabilities of the individual storage controllers, the storage resources will be more efficiently distributed based on the performance or functional needs of the virtual machine, reducing computing resource requirements and reducing power consumption. By adapting to updates in the storage requirements, the computer program product allows the efficient handling evolving workloads or applications that demand new or upgraded storage capabilities. By identifying a single storage controller that can accommodate all volumes with the required capabilities, the computer program product is effective to consolidate storage, reduce overhead, improve data locality, and streamline the management of the workloads. The computer program product is used within a multi-controller environment, allowing the system to scale to accommodate complex storage architectures and diverse virtual machine requirements. Dynamically reassigning volumes to meet updated requirements may provide enhanced fault tolerance, as resources may be redistributed responsive to potential performance or capability gaps.

In one embodiment, the at least one capability comprises one or more of the following: an input/output operations per second (IOPS) setting; replication; cloning; snapshotting; compression; volume encryption; and safeguarded copying. Beneficially, by tailoring storage provisioning based on specific technical capabilities, the computer program product ensures compatibility with a wide range of workload requirements. Compatibility with certain capabilities such as encryption, safeguarded copying, and replication provides improved data integrity and security. The IOPS setting allows storage controllers to be tuned to meet performance needs, improving the efficiency of resource utilization.

In one embodiment, identifying the single storage controller is based on one or more of the following: a count of volumes, of the plurality of volumes, to be reassigned to the single storage controller; a size of the plurality of volumes; an available capacity of a storage resource communicatively connected with the single storage controller; and one or more properties required by the storage resource. Beneficially, identifying the single storage controller allows more precise selection, which can result in better load balancing and efficient use of capacity and capabilities. Identifying the single storage controller can streamline reassignment by minimizing disruptions and downtime, and can improve the adaptability of the computer program product to larger, more complex systems by considering resource properties and controller capacity.

In one embodiment, receiving the update to the storage requirement comprises receiving a storage request. Beneficially, the computer program product supports dynamic allocation and enables real-time provisioning responsive to user or system demands.

In one embodiment, the operation further comprises: provisioning, among the plurality of storage controllers, at least a third storage configuration to meet storage requirements of at least a second virtual machine. Provisioning the second storage configuration to meet the update to the storage requirement comprises determining whether to reconfigure the third storage configuration. Beneficially, the computer program product provides resource conflict resolution through efficient resource distribution across multiple virtual machines, namely by evaluating the impact of changes on other configurations. The intelligent adjustments across the virtual machines can improve resource utilization without compromising performance, and offers flexibility to adapt to dynamic multi-tenant environments where resource demands are evolving.

In one embodiment, the operation further comprising: assigning a priority to each of the first virtual machine and the second virtual machine based on a respective count of volumes to be reassigned, wherein a lesser count corresponds to a greater priority. Provisioning the second storage configuration is in accordance with the assigned priority.

Beneficially, implementing a systematic, priority-based approach provides conflict mitigation by reducing contention for resources. Use of the priorities ensures that reconfigurations can be aligned with the urgency of needs, improving system reliability and user satisfaction. Further, prioritization supports a transparent and predictable process to resolve resource-constrained scenarios.

In one embodiment, receiving the update to the storage requirement is responsive to a periodic check of the volumes assigned to the plurality of storage controllers. The periodic check supports proactive maintenance by anticipating and resolving potential mismatches or inefficiencies before they impact performance. The computer program product can improve reliability by ensuring the storage configurations are aligned with up-to-date requirements.

According to one embodiment, a system comprises a memory and one or more processors configured to perform an operation comprising provisioning, among a plurality of storage controllers, a first storage configuration to meet a storage requirement of a first virtual machine according to capabilities provided by individual storage controllers of the plurality of storage controllers. The storage requirement comprises a plurality of volumes. In the first storage configuration at least a first volume of the plurality of volumes is assigned to a first storage controller of the plurality of storage controllers, and at least a second volume of the plurality of volumes is assigned to a second storage controller of the plurality of storage controllers. The operation further comprises receiving an update to the storage requirement of the first virtual machine, the update specifying at least one capability that is not provided in the first storage configuration. The operation further comprises provisioning, among the plurality of storage controllers, a second storage configuration to meet the update to the storage requirement. Provisioning the second storage configuration comprises identifying a single storage controller of the plurality of storage controllers that provides the at least one capability and sufficient capacity for the plurality of volumes. The operation further comprises assigning the plurality of volumes to the single storage controller.

The system may provide a number of benefits. By leveraging the capabilities of the individual storage controllers, the storage resources will be more efficiently distributed based on the performance or functional needs of the virtual machine, reducing computing resource requirements and reducing power consumption. By adapting to updates in the storage requirements, the system allows the efficient handling evolving workloads or applications that demand new or upgraded storage capabilities. By identifying a single storage controller that can accommodate all volumes with the required capabilities, the system is effective to consolidate storage, reduce overhead, improve data locality, and streamline the management of the workloads. The system is used within a multi-controller environment and scales to accommodate complex storage architectures and diverse virtual machine requirements. Dynamically reassigning volumes to meet updated requirements may provide enhanced fault tolerance, as resources may be redistributed responsive to potential performance or capability gaps.

In one embodiment, the at least one capability comprises one or more of the following: an input/output operations per second (IOPS) setting; replication; cloning; snapshotting; compression; volume encryption; and safeguarded copying. Beneficially, by tailoring storage provisioning based on specific technical capabilities, the system ensures compatibility with a wide range of workload requirements. Compatibility with certain capabilities such as encryption, safeguarded copying, and replication provides improved data integrity and security. The IOPS setting allows storage controllers to be tuned to meet performance needs, improving the efficiency of resource utilization.

In one embodiment, identifying the single storage controller is based on one or more of the following: a count of volumes, of the plurality of volumes, to be reassigned to the single storage controller; a size of the plurality of volumes; an available capacity of a storage resource communicatively connected with the single storage controller; and one or more properties required by the storage resource. Beneficially, identifying the single storage controller allows more precise selection, which can result in better load balancing and efficient use of capacity and capabilities. Identifying the single storage controller can streamline reassignment by minimizing disruptions and downtime, and can improve the adaptability of the system to larger, more complex systems by considering resource properties and controller capacity.

In one embodiment, receiving the update to the storage requirement comprises receiving a storage request. Beneficially, the system supports dynamic allocation and enables real-time provisioning responsive to user or system demands.

In one embodiment, the operation further comprises: provisioning, among the plurality of storage controllers, at least a third storage configuration to meet storage requirements of at least a second virtual machine. Provisioning the second storage configuration to meet the update to the storage requirement comprises determining whether to reconfigure the third storage configuration. Beneficially, the system provides resource conflict resolution through efficient resource distribution across multiple virtual machines, namely by evaluating the impact of changes on other configurations. The intelligent adjustments across the virtual machines can improve resource utilization without compromising performance, and offers flexibility to adapt to dynamic multi-tenant environments where resource demands are evolving.

In one embodiment, receiving the update to the storage requirement is responsive to a periodic check of the volumes assigned to the plurality of storage controllers. The periodic check supports proactive maintenance by anticipating and resolving potential mismatches or inefficiencies before they impact performance. The system can improve reliability by ensuring the storage configurations are aligned with up-to-date requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as an improved orchestration code 126 to dynamically provision storage responsive to responsive to changes in storage requirements for virtual machines. In addition to the orchestration code 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and orchestration code 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

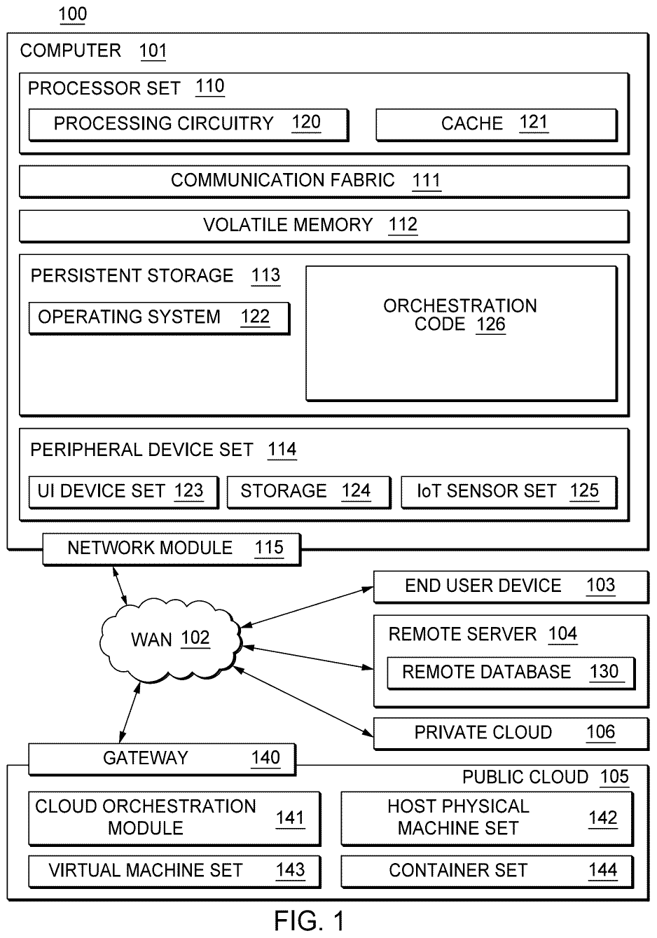

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the orchestration code 126 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in the orchestration code 126 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

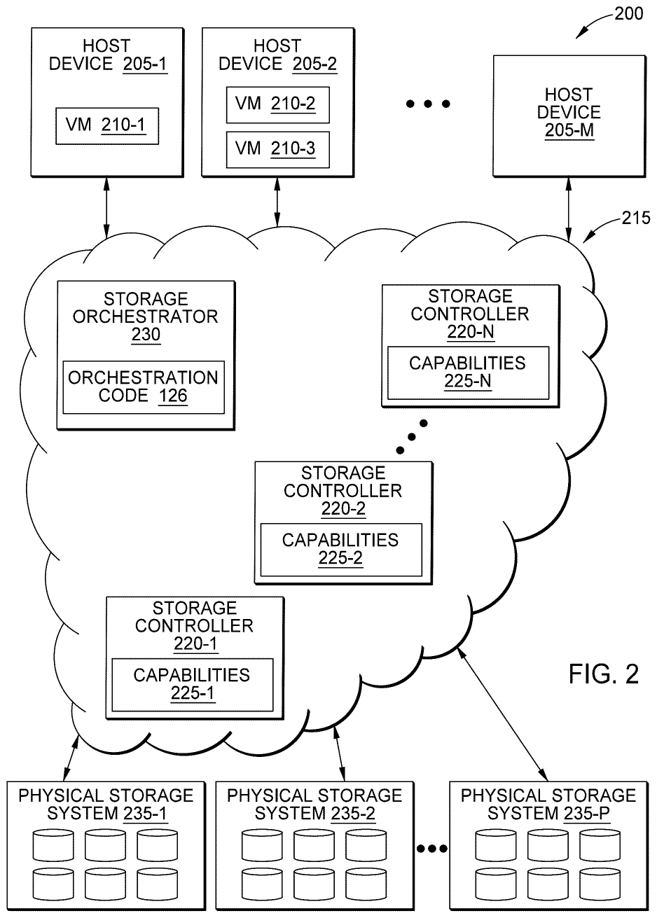

FIG. 2 is a block diagram of an exemplary system 200 for provisioning storage resources, according to one or more embodiments. The features of the system 200 may be used in conjunction with other embodiments. For example, a storage orchestrator 230 may run the orchestration code 126 of FIG. 1 to perform some or all of the functionality described herein.

The system 200 includes a plurality of host devices 205-1, 205-2, . . . , 205-M that are communicatively connected with a storage network 215. Each of the host devices 205-1, 205-2, . . . , 205-M may be implemented as a respective electronic device. As used herein, an “electronic device” generally refers to any device having electronic circuitry that provides a processing or computing capability, and that implements logic and/or executes program code to perform various operations that collectively define the functionality of the electronic device. The functionality of the electronic device includes a communicative capability with one or more other electronic devices, e.g., when connected to a same network. An electronic device may be implemented with any suitable form factor, whether relatively static in nature (e.g., mainframe, computer terminal, server, kiosk, workstation) or mobile (e.g., laptop computer, tablet, handheld, smart phone, wearable device). The communicative capability between electronic devices may be achieved using any suitable techniques, such as conductive cabling, wireless transmission, optical transmission, and so forth.

The electronic device comprises one or more processors and a memory. The one or more processors are any electronic circuitry, including, but not limited to one or a combination of microprocessors, microcontrollers, application-specific integrated circuits (ASIC), application-specific instruction set processors (ASIP), and/or state machines, that is communicatively coupled to the memory and controls the operation of the system. In some aspects, the electronic circuitry is configured to perform any of the functions described herein. Further, the one or more processors are not limited to a single processing device and may encompass multiple processing devices.

The one or more processors may include other hardware that operates software to control and process information. In some aspects, the one or more processors execute software stored in the memory to perform any of the functions described herein. The one or more processors control the operation and administration of the electronic device by processing information (e.g., information received from input devices and/or communicatively coupled electronic devices).

The memory may store, either permanently or temporarily, data, operational software, or other information for the one or more processors. The memory may include any one or a combination of volatile or non-volatile local or remote devices suitable for storing information. For example, the memory may include random-access memory (RAM), read-only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory, a disk, a CD, or a flash drive. In particular embodiments, the software may include an application executable by the one or more processors to perform one or more of the functions described herein.

Each of the host devices 205-1, 205-2, . . . , 205-M is configured to create and operate a respective one or more virtual machines (VMs) 210-1, 210-2, 210-3. As shown, the host device 205-1 operates a first VM 210-1, the host device 205-2 operates a second VM 210-2 and a third VM 210-3, although other configurations are also contemplated. Each of the VMs 210-1, 210-2, 210-3 implement any suitable functionality using provisioned computing resources (such as processors and storage).

The storage network 215 comprises a plurality of storage controllers 220-1, 220-2, . . . , 220-N that are communicatively connected with a plurality of physical storage systems 235-1, 235-2, . . . , 235-P. Each of the plurality of storage controllers 220-1, 220-2, . . . , 220-N may be implemented as a respective electronic device communicatively connected with a respective one or more of the plurality of physical storage systems 235-1, 235-2, . . . , 235-P. In some embodiments, each storage controller 220-1, 220-2, . . . , 220-N is communicatively connected with a respective one or more of the plurality of physical storage systems 235-1, 235-2, . . . , 235-P in a 1:1 ratio.

Each of the physical storage systems 235-1, 235-2, . . . , 235-P comprises a respective plurality of storage devices that are networked together by the storage controller 220-1, 220-2, . . . , 220-N according to any suitable networked storage protocols, such as iSCSI, Fibre Channel, NVMe, and so forth. Each storage controller 220-1, 220-2, . . . , 220-N manages its storage devices to provide block storage virtualization to the host devices 205-1, 205-2, . . . , 205-M in the form of virtualized disks.

Each storage controller 220-1, 220-2, . . . , 220-N provides a respective set of one or more capabilities 225-1, 225-2, . . . , 225-N for its managed storage devices. In some embodiments, different ones of the physical storage systems 235-1, 235-2, . . . , 235-P have storage devices that natively support different capabilities, e.g., different input/output operations per second (IOPS) rates, replication, encryption, and/or a type of compression that are specific to the hardware of the storage devices. In some cases, the different capabilities may be associated with different costs of the physical storage systems 235-1, 235-2, . . . , 235-P. For example, Fibre Channel-configured storage devices may support higher IOPS rates than iSCSI-configured storage devices, but tend to be more costly as requiring dedicated copper or optical fiber cabling.

In some embodiments, the set of one or more capabilities 225-1, 225-2, . . . , 225-N comprises one or more of the following: an input/output operations per second (IOPS) setting, replication, cloning, snapshotting, compression, volume encryption, and safeguarded copying. Other capabilities and combinations of capabilities are also contemplated.

In some embodiments, a client specifies the capabilities that will be provided with the storage resources to be provisioned for the VM(s), e.g., subscribing to or otherwise selecting the capabilities using inputs provided to the host device 205-1, 205-2, . . . , 205-M. In some embodiments, the client specifies the capabilities at a time of creating (or initially provisioning) the storage resources, e.g., when transmitting a storage resource request from the host device 205-1, 205-2, . . . , 205-M to a storage orchestrator 230 of the storage network 215. The storage orchestrator 230 may be implemented as an electronic device that is communicatively connected with the plurality of storage controllers 220-1, 220-2, . . . , 220-N and may further include the orchestration code 126.

In some embodiments, each of the VMs 210-1, 210-2, 210-3 has a storage requirement comprising a plurality of volumes. The storage orchestrator 230 may assign the plurality of volumes across the plurality of storage controllers 220-1, 220-2, . . . , 220-N to meet the specified capabilities (e.g., identifying those of the storage controllers 220-1, 220-2, ..., 220-N whose sets of capabilities 225-1, 225-2, . . . , 225-N meet the specified capabilities). The storage orchestrator 230 may further attempt to meet other objectives when assigning the plurality of volumes among the plurality of storage controllers 220-1, 220-2, . . . , 220-N, such as minimizing costs to the client and/or to the storage provider, ensuring suitable performance and/or availability of the provisioned resources, and so forth. Thus, in certain configurations, at least a first volume of a VM 210-1, 210-2, 210-3 may be assigned to a first storage controller 220-1, 220-2, . . . , 220-N, while at least a second volume of the same VM 210-1, 210-2, 210-3 may be assigned to a second storage controller 220-1, 220-2, . . . , 220-N.

Certain capabilities, however, require (or at least prefer) that all of the volumes for a particular VM 210-1, 210-2, 210-3 be assigned to a single storage controller 220-1, 220-2, . . . , 220-N. For example, these capabilities may operate at the level of the storage controller 220-1, 220-2, . . . , 220-N and specify that the volumes for a particular VM 210-1, 210-2, 210-3 should not be fragmented across multiple storage controllers 220-1, 220-2, . . . , 220-N (or across multiple physical storage systems 235-1, 235-2, . . . , 235-P).

The storage orchestrator 230 receives an update to the storage requirement of a VM 210-1, 210-2, 210-3 that specifies at least one capability that is not provided in a first storage configuration provisioned for the VM 210-1, 210-2, 210-3. In some embodiments, the at least one capability requires that the plurality of volumes for the VM 210-1, 210-2, 210-3 be assigned to a same storage controller.

The update to the storage requirement may be responsive to an upgrade (e.g., a new subscription) by the client or to other changes to the properties of the volumes. The storage orchestrator 230 provisions, among the plurality of storage controllers 220-1, 220-2, . . . , 220-N, a second storage configuration to meet the update to the storage requirement. In some embodiments, provisioning the second storage configuration comprises identifying a single storage controller of the plurality of storage controllers 220-1, 220-2, . . . , 220-N that provides the at least one capability and sufficient capacity for the plurality of volumes, and assigning the plurality of volumes to the single storage controller.

The storage orchestrator 230 considers multiple policies before performing the consolidation of the plurality of volumes (e.g., the reassignment of one or more volumes) onto a single storage controller 220-1, 220-2, . . . , 220-N. In some embodiments, identifying the single storage controller 220-1, 220-2, . . . , 220-N is based on one or more of the following: a count of volumes (of the plurality of volumes) to be reassigned to the single storage controller, a size of the plurality of volumes, an available capacity of a storage resource communicatively connected with the single storage controller, and one or more properties required by the storage resource. Other policies and combinations of policies are also contemplated.

In some embodiments, the storage orchestrator 230 considers only the particular VM 210-1, 210-2, 210-3 when determining the second storage configuration for the plurality of volumes of the VM 210-1, 210-2, 210-3. In other embodiments, the storage orchestrator 230 considers the volumes of other VMs 210-1, 210-2, 210-3 when determining the second storage configuration. For example, the storage orchestrator 230 may provision at least a third storage configuration to meet storage requirements of at least a second VM 210-1, 210-2, 210-3, and may determine whether to reconfigure the third storage configuration when provisioning the second storage configuration.

In some embodiments, the storage orchestrator 230 assigns a priority to the different VMs 210-1, 210-2, 210-3 (e.g., each of the first VM and the second VM) based on a respective count of volumes to be reassigned. A lesser count corresponds to a greater priority. In some embodiments, the volumes of a VM with a higher priority are reassigned prior to the volumes of a VM with a lower priority (e.g., storage resources are provisioned first for the higher-priority VM). In other embodiments, the volumes of a VM with a higher priority are given preference when determining the second storage configuration, third storage configuration, and so forth (e.g., the provisioning is performed at substantially a same time for the different VMs, but the storage configuration of the higher-priority VM is determined first).

The re-provisioning operations performed by the storage orchestrator 230 can be disruptive to the operation of the VMs 210-1, 210-2, 210-3 (e.g., causing a temporary interruption). In some embodiments, the storage orchestrator 230 performs a periodic check of the volumes assigned to the plurality of storage controllers 220-1, 220-2, . . . , 220-N. For example, the periodic check may be used to determine a current usage of the VMs 210-1, 210-2, 210-3 or of the volumes, which represents a measure of how disruptive the re-provisioning operations will be. Other techniques of determining a disruptiveness of the re-provisioning operations is also contemplated. The storage orchestrator 230 may begin re-provisioning for a particular VM 210-1, 210-2, 210-3 when the current usage is low or zero, or may schedule re-provisioning when the usage is expected to be low or zero.

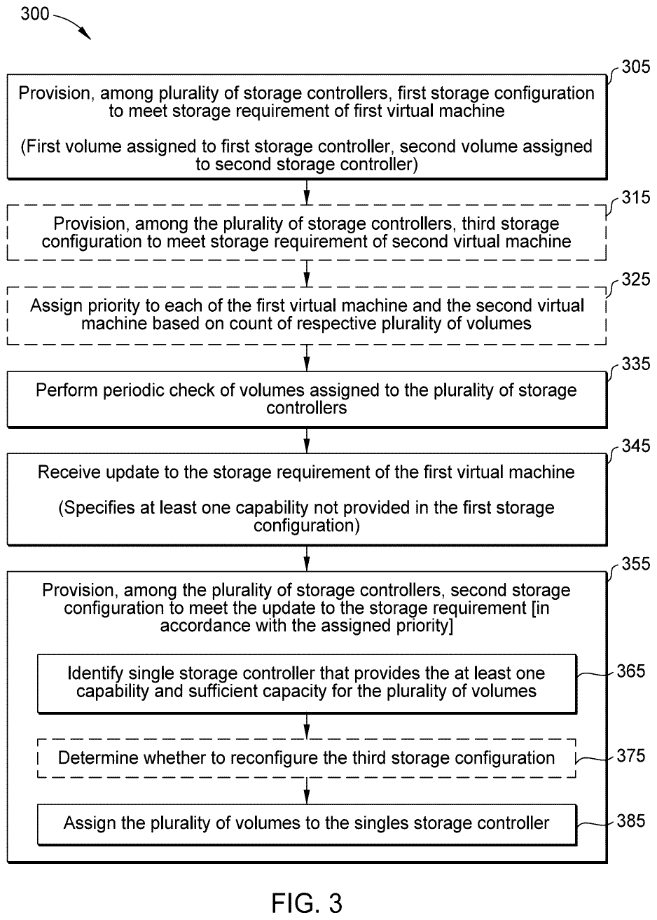

FIG. 3 is an exemplary method 300 of provisioning storage resources responsive to changes in storage requirements for virtual machines, according to one or more embodiments. The method 300 may be used in conjunction with other embodiments. For example, the method 300 may be performed by the storage orchestrator 230 of FIG. 2.

The method 300 begins at block 305, where the storage orchestrator 230 provisions, among a plurality of storage controllers, a first storage configuration to meet a storage requirement of a first VM. The storage requirement comprises a plurality of volumes, and in the first storage configuration at least a first volume of the plurality of volumes is assigned to a first storage controller of the plurality of storage controllers, and at least a second volume of the plurality of volumes is assigned to a second storage controller of the plurality of storage controllers.

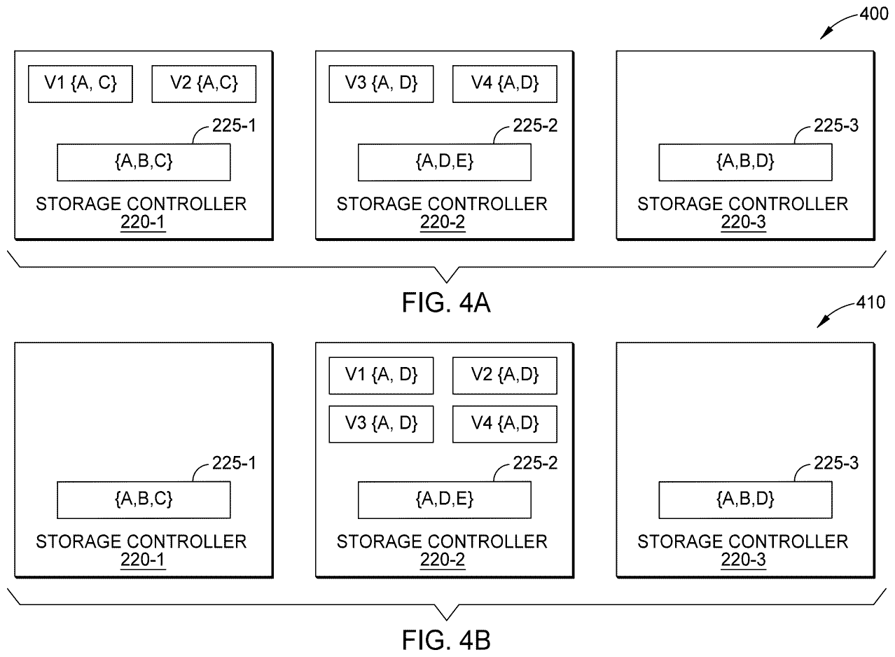

Refer also to FIG. 4A, which is a block diagram 400 that illustrates a first storage configuration for an exemplary VM. In the block diagram 400, the storage controller 220-1 has a set of capabilities 225-1 that includes the capabilities {A, B, C}, the storage controller 220-2 has a set of capabilities 225-2 that includes the capabilities {A, D, E}, and the storage controller 220-3 has a set of capabilities 225-3 that includes the capabilities {A, B, D}.

The VM has four volumes: V1 and V2 which require the capabilities {A, C}, and V3 and V4 which require the capabilities {A, D}. The storage orchestrator 230 assigns the volumes V1, V2 to the storage controller 220-1, and the volumes V3, V4 to the storage controller 220-2. The storage orchestrator 230 could alternately assign the volumes V3, V4 to the storage controller 220-3.

At an optional block 315, the storage orchestrator 230 provisions, among the plurality of storage controllers, a third storage configuration to meet a storage requirement of a second VM. The storage orchestrator 230 may further provision storage configurations for other VMs of the system 200. At an optional block 325, the storage orchestrator 230 assigns a priority of each of the first VM and the second VM. The optional blocks 315, 325 will be discussed in greater detail below with respect to another example.

At an optional block 335, the storage orchestrator 230 performs a periodic check of the volumes assigned to the plurality of storage controllers. In some embodiments, the periodic check comprises determining a current usage of the VMs or of the volumes.

At block 345, the storage orchestrator 230 receives an update to the storage requirement of the first VM. The update specifies at least one capability that is not provided in the first storage configuration. In some embodiments, receiving the update to the storage requirement is responsive to performing the periodic check of the volumes. In some embodiments, the update to the storage requirement may be responsive to an upgrade (e.g., a new subscription) by the client or to other changes to the properties of the volumes.

At block 355, the storage orchestrator 230 provisions, among the plurality of storage controllers, a second storage configuration to meet the update to the storage requirement. In some embodiments, provisioning the second storage configuration comprises (at block 365) identifying a single storage controller of the plurality of storage controllers that provides the at least one capability and sufficient capacity for the plurality of volumes, and (at block 385) assigning the plurality of volumes to the single storage controller. In some embodiments, provisioning the second storage configuration is in accordance with the assigned priority of the first VM.

In some embodiments, the storage orchestrator 230 determines at an optional block 375 whether to reconfigure the third storage configuration before assigning the plurality of volumes to the single storage controller at block 385. The optional block 375 will be discussed in greater detail below with respect to another example.

Refer also to FIG. 4B, which is a block diagram 410 that illustrates a second storage configuration for an exemplary VM. In this example, the update to the storage requirement comprises the client modifying the capability requirements of the volumes V1, V2 from {A, C} to {A, D}. The update to the storage requirement may further comprise the client defining an affinity of the volumes V1, V2. The storage orchestrator 230 assigns the volumes V1, V2, V3, V4 to the storage controller 220-2. The storage orchestrator 230 could alternately assign the volumes V1, V2, V3, V4 to the storage controller 220-3.

The method 300 ends following completion of block 355 (or of the block 385 included therein).

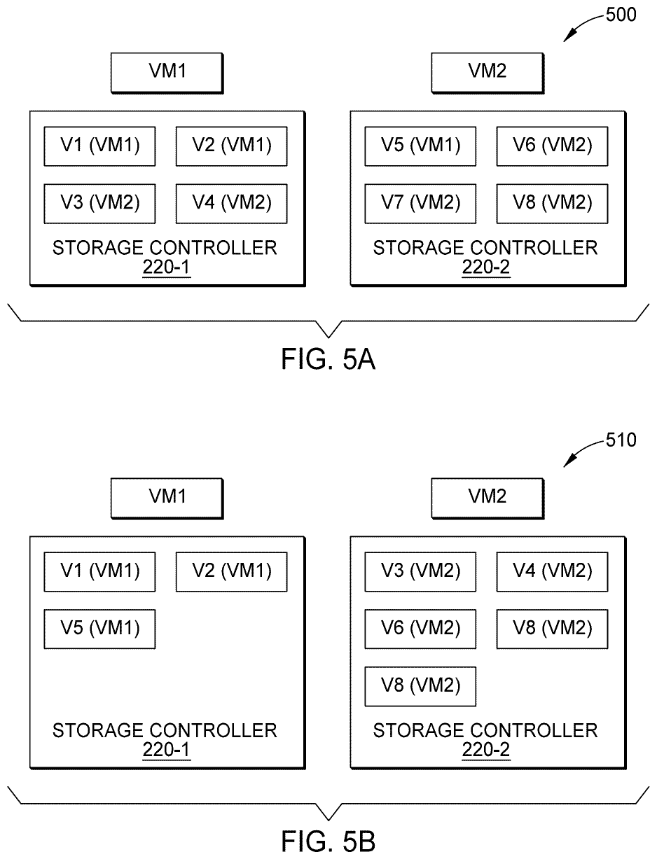

FIGS. 5A and 5B are block diagrams 500, 510 illustrating an exemplary sequence of provisioning storage resources responsive to changes in storage requirements for virtual machines, according to one or more embodiments. Returning to the block 305, the storage orchestrator 230 provisions the first storage configuration for VM1, in which volumes V1, V2 are assigned to the storage controller 220-1, and volume V5 is assigned to the storage controller 220-2. At the optional block 315, the storage orchestrator 230 provisions the third storage configuration for VM2, in which volumes V3, V4 are assigned to the storage controller 220-1, and volumes V6, V7, V8 are assigned to the storage controller 220-2.

At the optional block 325, the storage orchestrator 230 assigns a priority to VM1 and VM2. In some embodiments, VM1 has a minimum of one volume V5 to be reassigned and has a greater priority than VM2, which has a minimum of two volumes V3, V4 to be reassigned.

At block 345, the storage orchestrator 230 receives an update to the storage requirement of VM1. At block 355, the storage orchestrator 230 provisions the second storage configuration of VM1 (shown in block diagram 510) to meet the update to the storage requirement. At the optional block 375, the storage orchestrator 230 determines whether to reconfigure the third storage configuration of VM2 before assigning the plurality of volumes V1, V2, V5 to the single storage controller 220-1 at block 385.

While the foregoing is directed to embodiments of the present invention, other and further embodiments of the invention may be devised without departing from the basic scope thereof, and the scope thereof is determined by the claims that follow.

What is claimed is:

1. A method comprising:
provisioning, among a plurality of storage controllers, a first storage configuration to meet a storage requirement of a first virtual machine according to capabilities provided by individual storage controllers of the plurality of storage controllers, wherein the storage requirement comprises a plurality of volumes, and wherein in the first storage configuration at least a first volume of the plurality of volumes is assigned to a first storage controller of the plurality of storage controllers, and at least a second volume of the plurality of volumes is assigned to a second storage controller of the plurality of storage controllers;
receiving an update to the storage requirement of the first virtual machine, the update specifying at least one capability that is not provided in the first storage configuration; and
provisioning, among the plurality of storage controllers, a second storage configuration to meet the update to the storage requirement, wherein provisioning the second storage configuration comprises:
identifying a single storage controller of the plurality of storage controllers that provides the at least one capability and sufficient capacity for the plurality of volumes; and
assigning the plurality of volumes to the single storage controller.

2. The method of claim 1, wherein the at least one capability comprises one or more of the following:
an input/output operations per second (IOPS) setting;
replication;
cloning;
snapshotting;
compression;
volume encryption; and
safeguarded copying.

3. The method of claim 1, wherein identifying the single storage controller is based on one or more of the following:
a count of volumes, of the plurality of volumes, to be reassigned to the single storage controller;
a size of the plurality of volumes;
an available capacity of a storage resource communicatively connected with the single storage controller; and
one or more properties required by the storage resource.

4. The method of claim 1, wherein receiving the update to the storage requirement comprises receiving a storage request.

5. The method of claim 1, further comprising:
provisioning, among the plurality of storage controllers, at least a third storage configuration to meet storage requirements of at least a second virtual machine,
wherein provisioning the second storage configuration to meet the update to the storage requirement comprises determining whether to reconfigure the third storage configuration.

6. The method of claim 5, further comprising:
assigning a priority to each of the first virtual machine and the second virtual machine based on a respective count of volumes to be reassigned, wherein a lesser count corresponds to a greater priority,
wherein provisioning the second storage configuration is in accordance with the assigned priority.

7. The method of claim 1, wherein receiving the update to the storage requirement is responsive to a periodic check of the volumes assigned to the plurality of storage controllers.

8. A computer program product comprising:
a computer-readable storage medium having computer-readable program code embodied therewith, the computer-readable program code executable by one or more computer processors to perform an operation comprising:
provisioning, among a plurality of storage controllers, a first storage configuration to meet a storage requirement of a first virtual machine according to capabilities provided by individual storage controllers of the plurality of storage controllers, wherein the storage requirement comprises a plurality of volumes, and wherein in the first storage configuration at least a first volume of the plurality of volumes is assigned to a first storage controller of the plurality of storage controllers, and at least a second volume of the plurality of volumes is assigned to a second storage controller of the plurality of storage controllers;
receiving an update to the storage requirement of the first virtual machine, the update specifying at least one capability that is not provided in the first storage configuration; and
provisioning, among the plurality of storage controllers, a second storage configuration to meet the update to the storage requirement, wherein provisioning the second storage configuration comprises:
identifying a single storage controller of the plurality of storage controllers that provides the at least one capability and sufficient capacity for the plurality of volumes; and
assigning the plurality of volumes to the single storage controller.

9. The computer program product of claim 8, wherein the at least one capability comprises one or more of the following:
an input/output operations per second (IOPS) setting;
replication;
cloning;
snapshotting;
compression;
volume encryption; and
safeguarded copying.

10. The computer program product of claim 8, wherein identifying the single storage controller is based on one or more of the following:
a count of volumes, of the plurality of volumes, to be reassigned to the single storage controller;
a size of the plurality of volumes;
an available capacity of a storage resource communicatively connected with the single storage controller; and
one or more properties required by the storage resource.

11. The computer program product of claim 8, wherein receiving the update to the storage requirement comprises receiving a storage request.

12. The computer program product of claim 8, the operation further comprising:
provisioning, among the plurality of storage controllers, at least a third storage configuration to meet storage requirements of at least a second virtual machine,
wherein provisioning the second storage configuration to meet the update to the storage requirement comprises determining whether to reconfigure the third storage configuration.

13. The computer program product of claim 12, the operation further comprising:
assigning a priority to each of the first virtual machine and the second virtual machine based on a respective count of volumes to be reassigned, wherein a lesser count corresponds to a greater priority,
wherein provisioning the second storage configuration is in accordance with the assigned priority.

14. The computer program product of claim 8, wherein receiving the update to the storage requirement is responsive to a periodic check of the volumes assigned to the plurality of storage controllers.

15. A system comprising:
a memory; and
one or more processors configured to perform an operation comprising:
provisioning, among a plurality of storage controllers, a first storage configuration to meet a storage requirement of a first virtual machine according to capabilities provided by individual storage controllers of the plurality of storage controllers, wherein the storage requirement comprises a plurality of volumes, and wherein in the first storage configuration at least a first volume of the plurality of volumes is assigned to a first storage controller of the plurality of storage controllers, and at least a second volume of the plurality of volumes is assigned to a second storage controller of the plurality of storage controllers;
receiving an update to the storage requirement of the first virtual machine, the update specifying at least one capability that is not provided in the first storage configuration; and
provisioning, among the plurality of storage controllers, a second storage configuration to meet the update to the storage requirement, wherein provisioning the second storage configuration comprises:
identifying a single storage controller of the plurality of storage controllers that provides the at least one capability and sufficient capacity for the plurality of volumes; and
assigning the plurality of volumes to the single storage controller.

16. The system of claim 15, wherein the at least one capability comprises one or more of the following:
an input/output operations per second (IOPS) setting;
replication;
cloning;
snapshotting;
compression;
volume encryption; and
safeguarded copying.

17. The system of claim 15, wherein identifying the single storage controller is based on one or more of the following:
a count of volumes, of the plurality of volumes, to be reassigned to the single storage controller;
a size of the plurality of volumes;
an available capacity of a storage resource communicatively connected with the single storage controller; and
one or more properties required by the storage resource.

18. The system of claim 15, wherein receiving the update to the storage requirement comprises receiving a storage request.

19. The system of claim 15, the operation further comprising:
provisioning, among the plurality of storage controllers, at least a third storage configuration to meet storage requirements of at least a second virtual machine,
wherein provisioning the second storage configuration to meet the update to the storage requirement comprises determining whether to reconfigure the third storage configuration.

20. The system of claim 15, wherein receiving the update to the storage requirement is responsive to a periodic check of the volumes assigned to the plurality of storage controllers.
